(19) United States
(12) Patent Application Publication
(10) Pub. No.: US 2006/0198037 A1
(43) Pub. Date: Sep. 7, 2006

(54) Optical device assembly method using O-rings

(75) Inventors: Robert Steven Kulakofsky, Tucson, AZ (US); Horst Helmut Krupp, La Costa, CA (US); Justin Monroe Aubry, Oro Valley, AZ (US)

Correspondence Address: Robert Kulakofsky, PO Box 26761, Tucson, AZ, 85726, US

(73) Assignee: Robert Kulakofsky, Tucson, AZ (US)

(21) Appl. No.: 11/356,948

(22) Filed: Feb. 18, 2006

Related U.S. Application Data
(60) Provisional application No. 60/655,574, filed on Feb. 22, 2005.

(51) Int. Cl. G02B 7/02

(52) U.S. Cl. 359/830

(57) ABSTRACT

Our improved optical device assembly method uses O-rings to secure an internal optical component in place and protect it from making contact with the housing. Our method is affordable and easy to manufacture, it also eliminates the need for special tools, aperture reducing threaded inserts, adhesives or a considerable amount of time to assemble an optical device. Our preferred method of assembly is adjustable to a variance in the dimensions of the internal components. The housing (10) for this device contains a lens/magnifier (14) that is separated by use of two O-rings (12) which function to position and protect the internal components from making contact with the housing. A housing plate (16) will be mounted on the bottom of the optical device to hold the internal components in the upper housing.

### CROSS-REFERENCE TO RELATED APPLICATIONS

This application claims the benefit of PPA Ser. No. 60/655,574, filed Feb. 20, 2005 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to an optical application that requires a lens or other optical components to be spaced and properly seated in a cylindrical housing.

2. Prior Art

Previously, housings for optical devices had a cylindrical cavity and used various adhesives or threaded inserts to properly hold lenses or other magnification devices in a desired position. These methods are costly and time consuming to manufacture and require additional care to secure the internal components. Having an internal or external threaded device to enclose the lenses or other optical component requires special care to avoid causing damage to the internal components. For example, over-tightening a threaded insert can chip, scratch or crack the internal components. Threaded inserts decrease the aperture of an optical device because the overall thickness of the insert needs to be substantial to machine the part and to screw the insert into the housing. For the internal thread method, additional tools such as taps are needed to thread the inner diameter and threading would be needed on the mating part. The internal threaded insert is a standard practice that requires a special tool (commonly called a spanner wrench) to spin the insert until it makes proper contact with the lens or other internal components. These threaded devices add time to both the machining and assembly, which results in a higher production cost.

O-rings are currently used in optical devices for the purpose of water-proofing or sealing internal components from dust and foreign objects. Threaded inserts are used for the assembly of these devices.

Adhesives can damage internal components by dripping or flowing on them during the gluing process. In the case where items have been glued into an assembly, they cannot be removed without the use of chemicals to break down the adhesive, which can cause damage to the internal optical components.

The following patents are a few examples of optic components and housings that are assembled using adhesives. The method for securing optical parts in U.S. Pat. No. 5,050,963 to Murakami, Sep. 24, 1991 has three members which are secured with adhesive applied onto a groove. With this method, the three members are permanently secured and cannot be repaired without replacing the entire assembly. The lens holder for positioning and holding the objective lens in U.S. Pat. No. 5,781,351 to Muralami, Jul. 14, 1998 has two inner walls between which an annular shoulder portion is formed. Again, an adhesive agent is applied to a gap defined between the first inner wall and the outer ring of the objective lens.

3. Objects and Advantages

Accordingly, besides the advantages of the compressible O-ring to protect the internal component several objects and advantages of the invention are:
a) to provide an optical housing that can be manufactured quickly and at low cost;
b) to provide a closure whose production allows for a convenient and rapid assembly of the internal components;
c) to provide an assembly that eliminates the need for unnecessary operations and tooling;
d) to provide a closure that is flexible to the variance in dimensions of the internal components;
e) to provide an assembly that does not require a highly skilled worker to assemble the final product;
f) to provide an optical housing that properly seats the lenses, filters or other internal components with ease;
g) to provide an optical housing assembly that does not require adhesives;
h) to provide an optical housing that allows access to the internal components if repairs are needed;
i) to provide an assembly method that prevents damage to the optical components during assembly, as well as during the disassembly and reassembly of repairs;
j) to provide an optical housing that is sealed from moisture and dirt;
k) to provide an optical device with a large aperture

Further advantages will become apparent from a consideration of the ensuing description and drawings.

### SUMMARY

In accordance with the preferred assembly method, an optical device with a cylindrical cavity consists of O-rings to seat and separate the internal component from the housing material. The internal components are held in place from the compression of the O-rings. As the manufacturer, we are also concerned that our final product can be assembled without spending a lot of time, money and preferably not having to use an adhesive.

In the drawings, closely related figures to the preferred embodiment have the same number but different alphabetic suffixes.

### DRAWINGS—FIGURES

FIG. 1A shows an exploded view of our current application and preferred assembly method

FIG 1B shows a bottom view of the assembled device

FIG. 1C is a view in detail of the portion indicated by the section lines A-A in FIG. 1B

FIG. 1D is a view in detail of the portion indicated by the section circle B in FIG. 1C

FIG. 2A shows a bottom view of the assembled device without the lower housing plate

FIG. 2B is a view in detail of the portion indicated by the lines C-C in FIG. 2A, shows a similar assembly that uses a threaded insert

FIG. 2C is a view in detail of the portion indicated by the section circle D in FIG. 2B

FIG. 3A shows a bottom view of an assembly that uses a threaded insert

FIG. 3B is a view in detail of the portion indicated by the section lines E-E in FIG. 3A

FIG. 3C is a view in detail of the portion indicated by the section circle F in FIG. 3B

FIG. 4A shows a bottom view of an assembly similar to FIG. 3A

FIG. 4B is a view in detail of the portion indicated by the section lines G-G in FIG. 4A

FIG. 4C is a view in detail of the portion indicated by the section circle H in FIG. 4B

FIG. 5A shows a bottom view of an assembly with two optical components and a sleeve

FIG. 5B is a view in detail of the portion indicated by the section lines J-J in FIG. 5A

FIG. 5C is a view in detail of the portion indicated by the section circle K in FIG. 5B

### DRAWINGS—REFERENCE NUMERALS

10 housing

12 O-ring

14 lens/magnifier

16 housing plate

18 threaded insert

20 countersunk screw locations

22 contact point for the mentioned lens/magnifier

24 glass/filter

26 contact point for the mentioned glass/filter

28 sleeve

30 chamfer

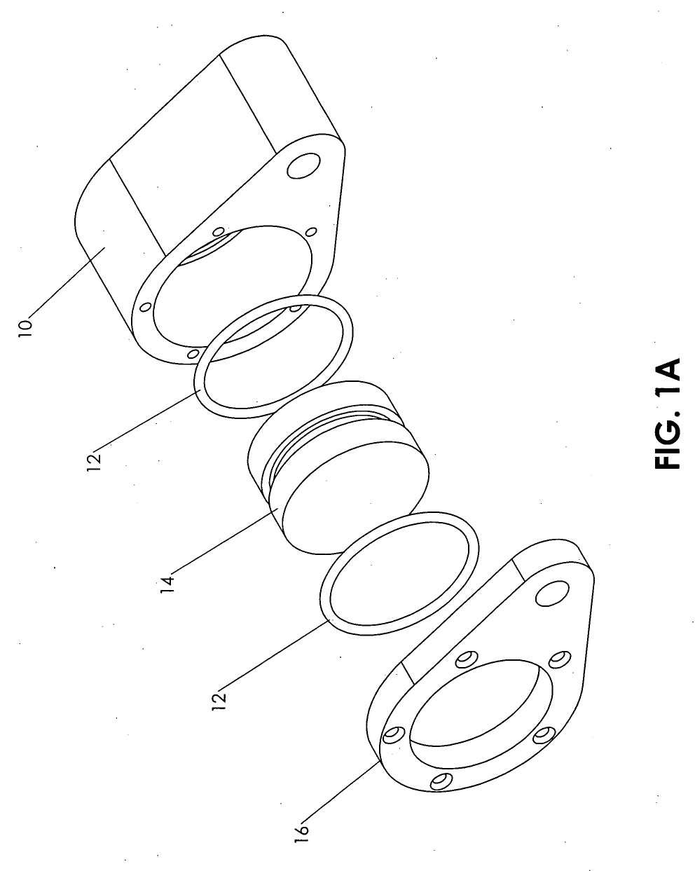

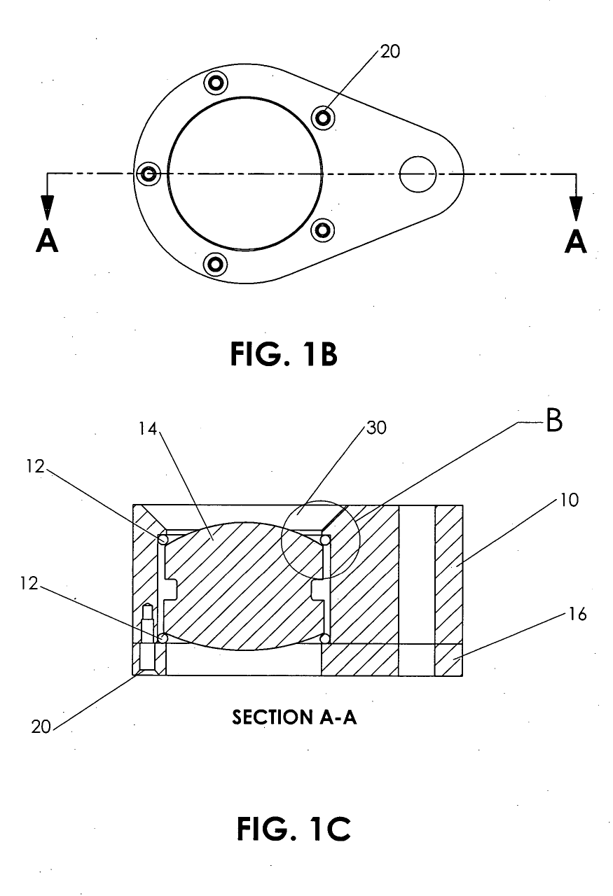

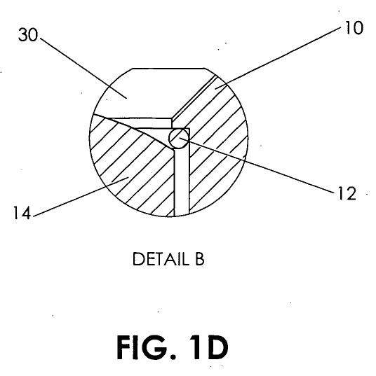

### Detailed Description—preferred Embodiment—FIGS. 1A, 1B, 1C, and 1D

A preferred embodiment of the assembly of the present invention is illustrated in FIG. 1A exploded view), FIG. 1B (bottom view), FIG. 1C (assembly section), and FIG. 1D (detailed view). As illustrated in FIG. 1A, a housing 10 will have three internal components that will be held in place with a housing plate 16. An O-ring 12 is the first internal component that is inserted into the housing, which will protect a lens/magnifier 14 from making contact with the housing material. In the current application, the lens/magnifier is the desired internal component that is being protected. The last internal component is a second O-ring 12 that will once again properly seat and protect the lens/magnifier from making contact with the housing plate. The housing plate will compress the O-rings to properly seat the internal lens/magnifier. The force created by compressing the O-rings will hold the internal components securely in place. For the current application the housing and housing plate are screwed together and a chamfer 30 shown in FIGS. 1C and 1D is provided to make the viewing end of the device obvious to the user. FIGS. 1B and 1C show the countersunk screw locations 20 for the current assembly method. Other methods can be used to assemble the two housing pieces, such as a housing that uses an adhesive or is made from a flexible material that snaps together. The housing can be made from materials such as polyethylene, polypropylene, nylon, rubber, various plastic materials, metal and any combination of these materials. The O-rings can consist of any material that is flexible enough to compress properly to seat the internal optic components.

### Operation—Preferred Embodiment—FIGS. 1A, 1B, 1C, and 1D

In operation, the finished preferred assembly is a handheld device commonly called a loupe that is used in many industries to inspect items under magnification. In the present invention the lens/magnifier is used for finding inclusions or fractures to be able to grade the overall quality of gemstones, identification of mineral types, close inspection of antiquities, etc. This device is only one example of how the assembly method can be applied.

The current assembly method of our competitors uses a threaded insert. The overall thickness of the threaded insert needs to be substantial to support the machining operation and placement of the insert into the housing. Using an O-ring instead of a threaded insert increases the aperture of the device. Our preferred embodiment with O-rings has an aperture of approximately 11% over the threaded insert method used by our competitors with the same internal optical components. The increased aperture allows more light through the device which produces a brighter image. The preferred assembly method has the added advantage of being able to be disassembled for repairs to the device.

As illustrated in FIG. 1A, a housing 10 will have three internal components that will be held in place with a housing plate 16. An O-ring 12 is the first internal component that is inserted into the housing, which will protect a lens/magnifier 14 from making contact with the housing material. In the current application the lens/magnifier is the desired internal component that is being protected by both the housing and internally by the O-rings. The last internal component is a second O-ring 12 that will once again properly seat and protect the lens/magnifier from making contact with the housing. The function of the housing is to protect the internal components and its shape is important to the handheld device in the current application. To make the viewing end of the device obvious to the user, the housing has a chamfer 30 on the viewing end which is shown in FIGS. 1C and 1D. The housing is manufactured so that when the housing and housing plate meet they will compress the two O-rings to properly seat and space the lens away from the housing surface. The O-rings also seal the housing so the internal components will not be affected by moisture.

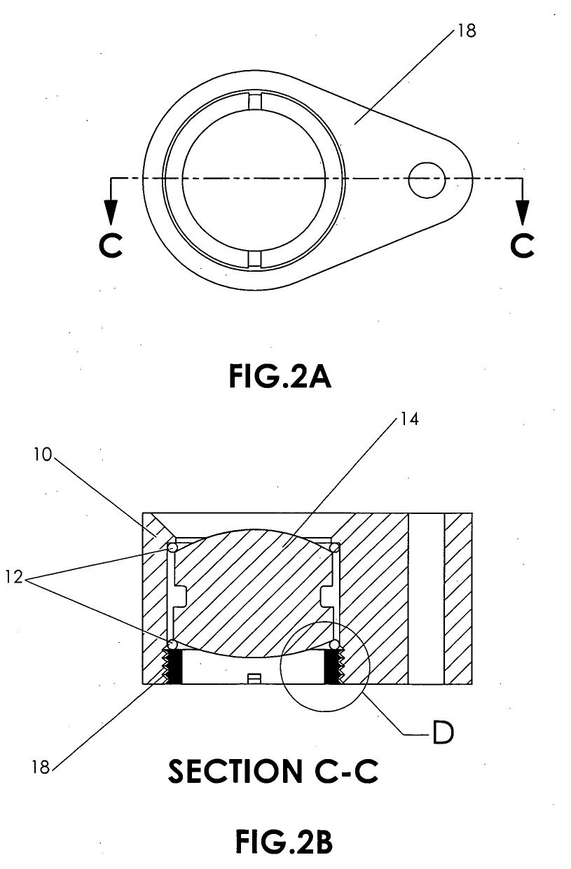

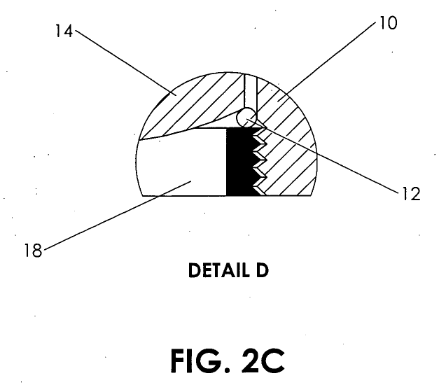

### Description—Alternative Embodiment—FIGS. 2-5

Additional embodiments are shown in FIGS. 2A-2C, 3A-3C, 4A-4C and 5A-5C; in each case the changes made still provide the proper seating, separation and protection of the internal components.

In FIG. 2A and 2B a threaded insert 18 is used to hold the internal components in the housing. This assembly method is similar to the preferred method FIGS. 1A-1D which keeps the lens/magnifier properly seated and separated from the housing material. FIG. 2C is a view in detail of the portion indicated by the section circle D in FIG. 2B which shows how an O-ring or washer can be used to protect the lens/magnifier from the threaded insert. The metal threaded inserts may chip or scratch the lens/magnifier or other optical components when tightened. A plastic threaded insert is less likely to cause damage.

The O-ring assembly method increases the aperture of the device compared to using threaded inserts that require threads on both the housing and the threaded insert. The overall thickness of the threaded insert needs to be substantial to support the machining operation and placement of the insert into the housing. This method is not being used because it is too similar to our competitor's ideas and requires a special tool to insert the threaded retainer. More importantly the threading is an added expense and is more time consuming for mass production.

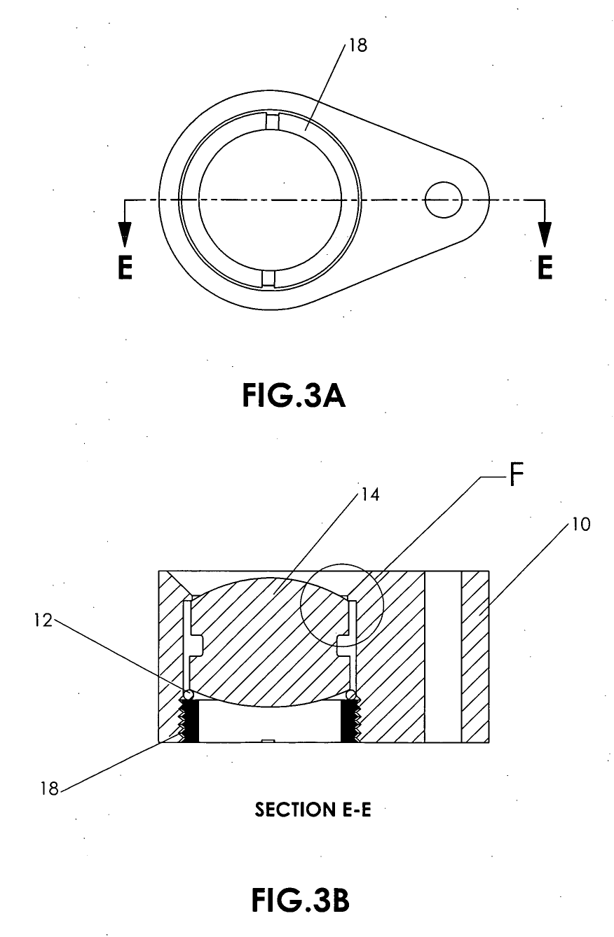

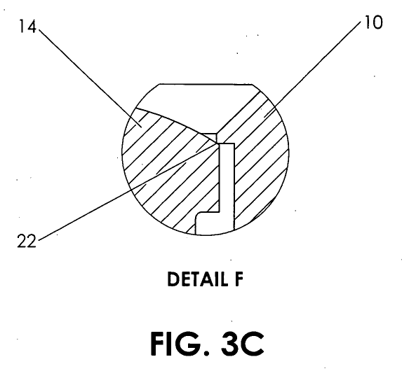

In FIGS. 3A and 3B the threaded insert is used again similar to the method in FIG. 2A-2C. The difference between the two methods can be seen in FIGS. 3B and 3C because only one O-ring is used to protect the lens/magnifier from the threaded insert. However, the lens/magnifier makes direct contact with the housing at contact point for the mentioned lens/magnifier 22 shown in FIG. 3C. This method can be used if the housing is made from plastic, Delrin or another otherwise soft material that will not damage the lens/magnifier. The upper housing can be made of metal if care is taken during assembly, and the contact point for the mentioned lens/magnifier has a small chamfer. Then, no sharp edges will contact he lens/magnifier that could cause damage. A compressible material such as a Teflon or rubber washer can also be inserted between the lens/magnifier and metal housing to provide cushioning at the mentioned contact point.

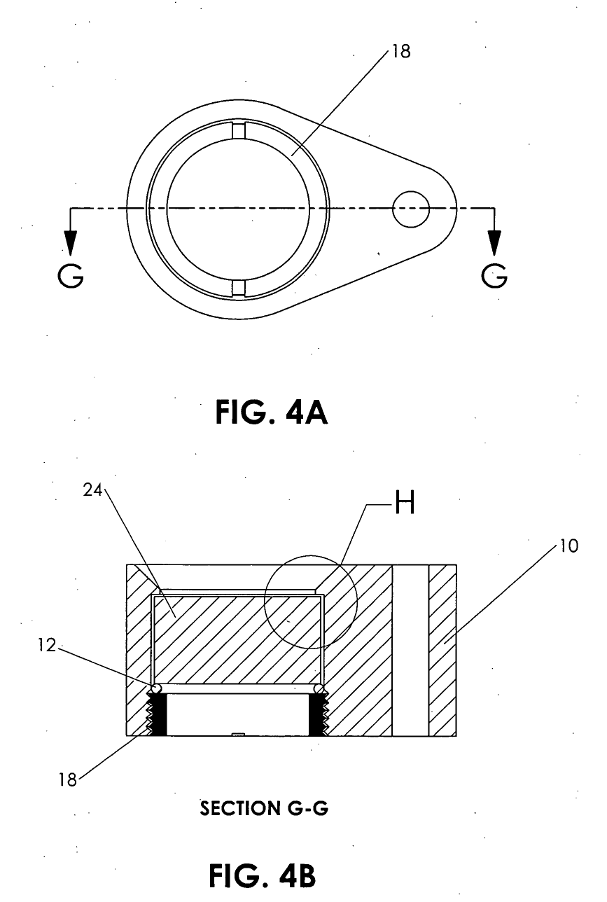

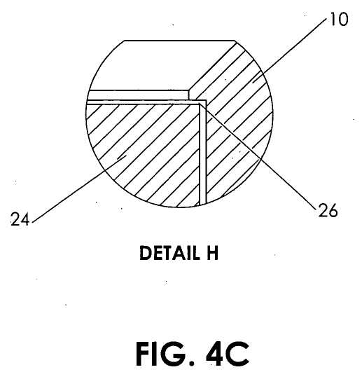

In FIG. 4B the threaded insert and O-ring are used to hold a glass/filter 24 in the housing. This method demonstrates how a different shape of a lens, glass, filter or other optical related component will be properly seated and separated from the housing. This housing also shows how the O-ring being used can be replaced with a gasket, washer, or other flat disc material that will protect the glass/filter from becoming damaged by the threaded insert. A contact point for the mentioned glass/filter 26 is shown in FIG. 4C. It should be noted this direct contact between the glass/filter and the housing material can use a gasket, washer or other flat disc material.

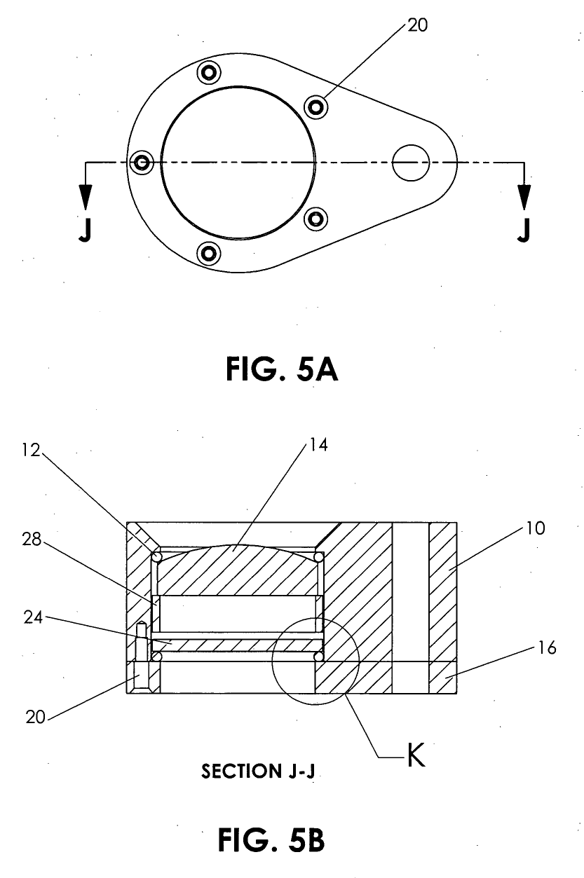

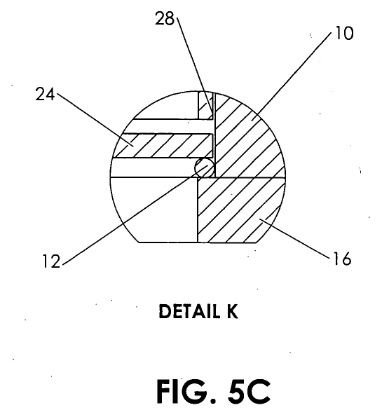

In FIG. 5B a sleeve 28 is used to separate two optical components. In this case the lens/magnifier and glass/filter are being separated. This method creates a space between the two optical components that can be a problem if water is not kept from entering the housing. The O-rings eliminate this problem by sealing the housing from moisture. Compared to our preferred method, this assembly has a larger number of parts, which adds expense. The sleeve as illustrated best in FIG. 5B could be replaced with a spring. The use of a spring is covered in our previous provisional patent, PPA Ser. No. 60/629,885, filed Nov. 19, 2004 by two of the present inventors. FIG. 5C is a view in detail of the portion indicated by the section circle K in FIG. 5B which shows the sleeve making direct contact with the glass/filter. The sleeve separates and seats the internal components. If a metal sleeve is used, a gasket or washer made from a variety of soft materials, can be used to protect the optical components from damage.

### Conclusion, Ramifications, and Scope

Our design eliminates the need for special tools, adhesives or a considerable amount of time for assembly of an optical device. With O-rings being used to separate the lens/magnifier from the housing and housing plate, the internal components will be protected from damage caused by contact with the housing. With this method, the O-rings and internal components could be held in the housing using a threaded insert as shown in FIGS. 2A-2C, 3A-3C and 4A-4C. The metal threaded inserts may chip or scratch the lens/magnifier or other optical components when tightened. Our assembly method uses O-rings to avoid this problem. However it is not recommended because our preferred method has been developed to eliminate these additional processes for the assembly. After the internal components have been placed into the housing, a housing plate is used to enclose the components. Furthermore, the optical device assembly method has the additional advantages in that
it provides an optical housing that can be manufactured quickly and at low cost;
it provides a closure whose production allows for a convenient and rapid assembly of the internal components;
it provides an assembly that eliminates the need for unnecessary operations and tooling;
it provides a closure that is flexible to the variance in dimensions of the internal components;
it provides an assembly that does not require a highly skilled worker to produce the final product;
it provides an optical housing that properly seats the lenses, filters or other internal components with ease;
it provides an optical housing assembly that does not require adhesives;
it provides an optical housing that allows access to the internal components if repairs are needed;
it provides an assembly method that prevents damage to the optical components during assembly and if repairs are needed;
it provides an optical housing that is sealed from moisture and dirt;
it provides an optical device with a large aperture

While the above description contains much specificities, these should not be construed as limitations on the scope of the invention, but rather as an exemplification of one preferred embodiment thereof. Many other variations are possible. For example, the housing is not limited to one particular diameter or material such as plastic, aluminum, steel, etc. The inside and outside diameters are determined by the material being used for the housing and by the size of the lens, filter, mirror, and other possible internal components. The shape of the housing does not have to be cylindrical as long as the housing can accommodate the circular lens and other related internal components. For example, the housing could have a rectangular shape and then have a bored center. This type of cavity could also be cast and later machined if needed. The optical assembly could use a mentioned retaining method at both ends of the device. For example, the housing could use a threaded insert at both ends to make them accessible for repairs.

Accordingly the reader will see that the O-rings used in the preferred method will separate and seat the internal components while the lower housing plate will allow the assembly to be repaired if needed. In addition, the assembly does not require a highly skilled worker to assemble the final product. The lens/magnifier or glass/filter described in the preferred and additional embodiments can be replaced with a variety of materials in any of the mentioned optical assemblies. For example the filter could be a piece of protective glass, plastic, mirror or other optical element. The type of materials present inside the housing are not limited to the numbers previously mentioned. For example a piece of glass could be placed in front of the lens to protect the more expensive lens from getting scratched or damaged. The same is true for the opposite end of the housing. Also the assembly is not limited to only one compressible item to separate and space internal components. For example, two or more O-rings, disc washers or other compressible items could be used in series to properly seat and separate different lenses, filters, mirrors and other materials.

When the housing and housing plate are made from plastic or another soft material the two parts could be assembled using a snap or adhesive. Using this described method along with O-rings would be ideal for mass production. It should be noted that the housing in this method would not likely be accessible for repairs. If manufactured from plastic, the housing would be inexpensive enough to replace the entire unit without the need to access internal parts.

Accordingly, the scope of the invention should be determined not by the embodiments illustrated, but by the appended claims and their legal equivalents.

1. An optical device assembly method, comprising:
1 a housing with a cylindrical cavity for accommodating a variety of internal components
2 an O-ring as a means to seat internal components
3 said O-ring as a means to cushion said internal components
4 a housing plate as a means to enclose internal components in said housing
